(19) United States
(12) Patent Application Publication
(10) Pub. No.: US 2026/0344641 A1
(43) Pub. Date: Nov. 5, 2026

(54) SYSTEM AND METHOD FOR DETERMINING A FLUID APPLICATION RATE BASED ON A FIELD AREA OF AN AGRICULTURAL FIELD

(71) Applicant: Precision Planting LLC, Tremont, IL (US)

(72) Inventor: Andrew Baer, Tremont, IL (US)

(21) Appl. No.: 19/484,719

(22) PCT Filed: Jan. 17, 2024
(86) PCT No.: PCT/IB2024/050449

§ 371 Date: Nov. 14, 2025

Related U.S. Application Data
(60) Provisional application No. 63/502,501, filed on May 16, 2023.

(51) Int. Cl. A01M 7/00; A01C 23/00; B05B 13/00

(52) U.S. Cl. CPC A01M 7/0089; A01C 23/007; B05B 13/005

(57) ABSTRACT

An implement comprises a fluid tank to store a volume, quantity, or amount of fluid, fluid dispensers\ disposed along the implement to apply a fluid application as the implement travels through an agricultural field, and a processing system including a processor that is configured to receive a field area of a field for a fluid application or to calculate the field area based on driving the implement around a perimeter of the agricultural field, to receive an input for a minimum fluid application rate and a maximum fluid application rate, and to determine a first application rate for applying the volume, quantity, or amount of fluid currently in the fluid tank to a fluid application area of the field in order to empty the volume, quantity, or amount of fluid from the fluid tank when completing the fluid application to the fluid application area.

### CROSS REFERENCE TO RELATED APPLICATIONS

This application claims priority to U.S. Application No. 63/502501, filed 16 May 2023, which is incorporated herein by reference in its entirety.

### FIELD

Various embodiments of the present disclosure generally relate to systems and a method for determining an application rate. In particular, some embodiments relate to a system and method for determining a fluid application rate based on a field area of an agricultural field and a volume, quantity, or amount of fluid available in a fluid tank of an implement.

### BACKGROUND

Sprayers and other fluid application systems are used to apply fluids (such as fertilizer, herbicide, insecticide, and/or fungicide) to fields. A rate control system determines an application rate for applying fluids to a field. However, if any fluid is left in a fluid tank of a sprayer after completing a complete application pass across a field, then the sprayer will have to double spray over some areas of the field to finish off fluid in the fluid tank. Alternatively, if the number of remaining acres is not known, then there may not be enough material to spray.

### BRIEF SUMMARY

In an aspect of the disclosure there is provided an implement comprising a fluid tank to store a volume, quantity, or amount of fluid, a plurality of fluid dispensers disposed along the implement to apply a fluid application as the implement travels through an agricultural field, and a processing system including a processor that is configured to receive a field area of a field for a fluid application or to calculate the field area based on driving the implement around a perimeter of the agricultural field, to determine a volume, quantity, or amount of fluid in the fluid tank based on filling of the fluid into the fluid tank of the implement or based on a tank sensor to measure a volume, quantity, or amount of fluid in the fluid tank, to receive an input for a minimum fluid application rate and a maximum fluid application rate based on fluid label instructions, and to determine a first application rate for applying the volume, quantity, or amount of fluid currently in the fluid tank to a fluid application area of the field based on the fluid application area and the volume, quantity, or amount of fluid currently in the fluid tank in order to empty the volume, quantity, or amount of fluid from the fluid tank when completing the fluid application to the fluid application area.

In one example of the implement, wherein the first application rate is selected to be applied during the fluid application when the first application rate falls within the minimum application rate and the maximum application rate.

In one example of the implement, wherein the processor is further configured to determine whether a predetermined number of application passes for a route of the implement through the fluid application area has occurred.

In one example of the implement, wherein the processor is further configured, given a predetermined number of application passes for a route of the implement through the fluid application area has occurred, to determine a second application rate for applying a remaining volume, quantity, or amount of fluid in the fluid tank to a region of the fluid application area that has not received the fluid application based on an area of this region and the remaining volume, quantity, or amount of fluid in the fluid tank.

In one example of the implement, wherein the fluid application area is less than the field area of the field.

In an aspect of the disclosure there is provided a system comprising memory to store fluid application data for a fluid tank of an implement and field data for one or more fields and a processor communicatively coupled to the memory. The processor is configured to receive a field area of a field for a fluid application or to calculate the field area by driving the implement around a perimeter of the field, to determine a volume, a quantity, or an amount of fluid in the fluid tank of the implement based on filling of the fluid into the fluid tank of the implement or based on a tank sensor to measure a volume, quantity, or amount of fluid in the fluid tank, to receive an input for a minimum fluid application rate and a maximum fluid application rate based on fluid label instructions, and to determine an application rate for applying the volume, quantity, or amount of fluid currently in the fluid tank to a fluid application area of the field based on the minimum fluid application rate, the maximum fluid application rate, a fluid application area, and the volume, quantity, or amount of fluid currently in the fluid tank in order to empty the volume, quantity, or amount of fluid from the fluid tank when completing the fluid application to the fluid application area.

In one example of the system, wherein the fluid application area is less than the field area of the field.

In one example, the amount of fluid application is more than the field area of the field.

In one example of the system, wherein the processor is further configured to determine a non-fluid application area for non-fluid application regions.

In one example of the system, wherein the processor is further configured to subtract the non-fluid application area from the field area to determine the fluid application area within the field.

In one example of the system, wherein the implement comprises a tractor or a sprayer.

In an aspect of the disclosure there is provided a computer-implemented method, comprising receiving a field area of a field for a fluid application or calculating the field area by driving an implement around a perimeter of the field, determining a volume, quantity, or amount of fluid in a fluid tank based on filling of the fluid into the fluid tank of the implement or based on a tank sensor to measure a volume, quantity, or amount of fluid in the fluid tank, receiving an input for a minimum fluid application rate and a maximum fluid application rate based on fluid label instructions, and determining a first application rate for applying the volume, quantity, or amount of fluid currently in the fluid tank to a fluid application area of the field based on the fluid application area and the volume, quantity, or amount of fluid currently in the fluid tank in order to empty the volume, quantity, or amount of fluid from the fluid tank when completing the fluid application to the fluid application area.

In one example of the computer-implemented method, wherein the first application rate is selected to be applied during the fluid application when the first application rate falls within the minimum application rate and the maximum application rate.

In one example of the computer-implemented method, further comprising determining whether a predetermined number of application passes for a route of the implement through the fluid application area has occurred.

In one example of the computer-implemented method, further comprising given a predetermined number of application passes occurring for a route of the implement through the fluid application area, determining a second application rate for applying a remaining volume, quantity, or amount of fluid in the fluid tank to a region of the fluid application area that has not received a fluid application based on an area of this region and the remaining volume, quantity, or amount of fluid in the fluid tank.

In one example of the computer-implemented method, further comprising determining whether a predetermined number of application passes remains for a route of the implement through the fluid application area.

In one example of the computer-implemented method, further comprising given a predetermined number of application passes remaining for a route of the implement through the fluid application area, determining a third application rate for applying a remaining volume, quantity, or amount of fluid in the fluid tank to a region of the fluid application area that has not received the fluid application based on an area of this region and the remaining volume, quantity, or amount of fluid in the fluid tank.

In one example of the computer-implemented method, wherein the fluid application area is less than the field area of the field.

In one example of the computer-implemented method, further comprising determining a non-fluid application area for non-fluid application regions.

In one example of the computer-implemented method, further comprising subtracting the non-fluid application area from the field area to determine the fluid application area within the field.

In one example of the computer-implemented method, wherein the implement comprises a tractor or a sprayer.

### BRIEF DESCRIPTION OF THE DRAWINGS

FIG. 1 is an illustration of an agricultural crop sprayer.

FIG. 2 is a rear elevation view of a spray boom with cameras according to one embodiment.

FIG. 3 is a rear elevation view of a spray boom with cameras according to another embodiment.

FIG. 4 illustrates a flow diagram of one embodiment for a computer-implemented method of determining a fluid application rate prior to or during an application pass to apply fluids (e.g., fertilizer, herbicide, insecticide, and/or fungicide, etc.) to a fluid application area of a field based on the fluid application area, amount of acreage remaining in the fluid application area to receive the fluid application, and a volume, a quantity, or an amount of fluid in a tank of an implement (e.g., an agricultural vehicle, planter, cultivator, plough, sprayer, spreader, a side-dress bar, a seeder, an irrigator, a center pivot irrigator, a tillage implement, a tractor, a cart, or a robot, etc.).

FIG. S illustrates a route of an implement (e.g., an agricultural vehicle, planter, cultivator, plough, sprayer, spreader, a side-dress bar, a seeder, an irrigator, a center pivot irrigator, a tillage implement, a tractor, a cart, or a robot, etc.) traversing a field 500 for a fluid application pass in accordance with one embodiment.

FIG. 6A shows an example of a block diagram of a self-propelled implement 140 (e.g., sprayer, spreader, irrigation implement, etc.) in accordance with one embodiment.

FIG. 6B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

### DETAILED DESCRIPTION

All references cited herein are incorporated herein in their entireties. If there is a conflict between a definition herein and in an incorporated reference, the definition herein shall control.

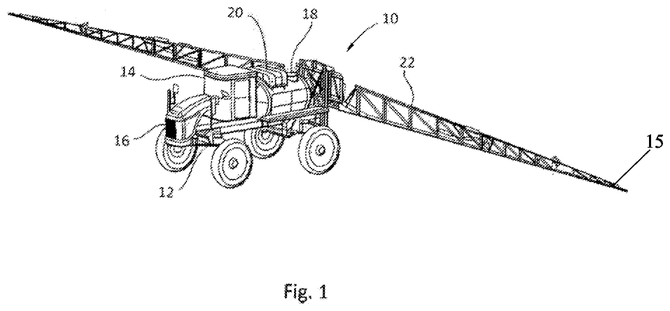

Referring to the drawings, wherein like reference numerals designate identical or corresponding parts throughout the several views, FIG. 1 illustrates an agricultural implement, such as a sprayer 10. While the system 15 can be used on a sprayer, the system can be used on any agricultural implement that is used to apply fluid to soil, such as a side-dress bar, a planter, a seeder, an irrigator, a center pivot irrigator, a tillage implement, a tractor, a cart, or a robot. A reference to boom or boom arm herein includes corresponding structures, such as a toolbar, in other agricultural implements.

Conventional approaches for applying fluid to a field will determine a fluid application rate based on an amount of fluid needed for an application such as fertilizer, herbicide, insecticide, and/or fungicide. However, when finishing a field, the operator may want to empty fluid in the tank of the sprayer or implement or not run out before the end of field. If any fluid is left in the tank, then the sprayer will have to double spray over some area to finish off fluid in the tank or move to a different field to finish off fluid left in the tank. This is inefficient use of fluid, costs more for buying the fluid product, additional time spent in applying fluid, and additional fuel expense for the self propelled sprayer or implement being towed by a tractor. In one example, an initial pass through a field may apply 20 gal/acre and have remaining fluid left in a tank. A second pass of certain areas is then performed with 10 gal/acre.

Some embodiments of the present disclosure relate to a fluid spray system and method for initially determining an initial application rate based on a field size and an amount of fluid available in a fluid tank in order to evenly apply the fluid to the field and have no fluid left in the tank at the end of the application session. One or more subsequent application rates after performing passes of a portion of the field can be determined based on an area of acreage left to be applied with the fluid. A fluid is a liquid, gas, mixture, or other material that continuously deforms under an applied shear stress, or external force.

FIG. 1 shows an agricultural crop sprayer 10 used to deliver chemicals to agricultural crops in a field. Agricultural sprayer 10 comprises a chassis 12 and a cab 14 mounted on the chassis 12. Cab 14 may house an operator and a number of controls for the agricultural sprayer 10. An engine 16 may be mounted on a forward portion of chassis 12 in front of cab 14 or may be mounted on a rearward portion of the chassis 12 behind the cab 14. The engine 16 may comprise, for example, a diesel engine or a gasoline powered internal combustion engine. The engine 16 provides energy to propel the agricultural sprayer 10 and also can be used to provide energy used to spray fluids from the sprayer 10.

Although a self-propelled application machine is shown and described hereinafter, it should be understood that the embodied invention is applicable to other agricultural sprayers including pull-type or towed sprayers and mounted sprayers, e.g. mounted on a 3-point linkage of an agricultural tractor, such as planters, seeders, striptill bars, or sidedress bars.

The sprayer 10 further comprises a fluid storage tank 18 used to store a spray fluid to be sprayed on the field. The spray fluid can include chemicals, such as but not limited to, herbicides, pesticides, and/or fertilizers. Fluid storage tank 18 is to be mounted on chassis 12, either in front of or behind cab 14. The crop sprayer 10 can include more than one storage tank 18 to store different chemicals to be sprayed on the field. The stored chemicals may be dispersed by the sprayer 10 one at a time or different chemicals may be mixed and dispersed together in a variety of mixtures. The sprayer 10 further comprises a rinse water tank 20 used to store clean water, which can be used for storing a volume of clean water for use to rinse the plumbing and main tank 18 after a spraying operation.

At least one boom arm 2 on the sprayer 10 is used to distribute the fluid from the fluid tank 18 over a wide swath as the sprayer 10 is driven through the field. The boom arm 22 is provided as part of a spray applicator system 15 as illustrated in FIGS. 1-3, which further comprises an array of spray nozzles (in addition to lights, cameras, and processors described later) arranged along the length of the boom arm 22 and suitable sprayer plumbing used to connect the fluid storage tank 18 with the spray nozzles. The sprayer plumbing will be understood to comprise any suitable tubing or piping arranged for fluid communication on the sprayer 10. Boom arm 22 can be in sections to permit folding of the boom arm for transport.

Additional components that can be included, such as control modules or lights, are disclosed in PCT Publication No. WO 2020/178663 and U.S. Application No. 63/050,314, filed 10 Jul. 2020, respectively.

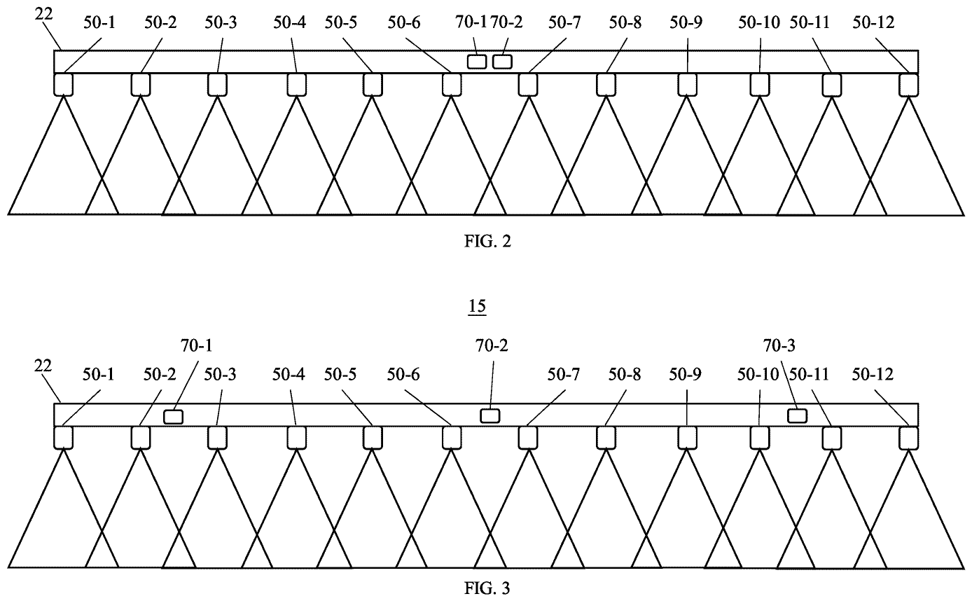

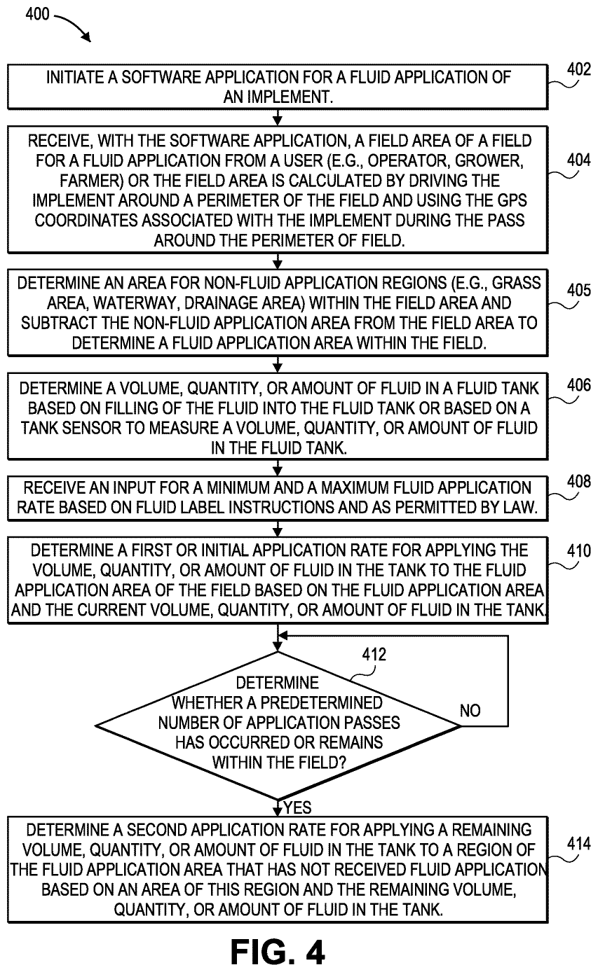

Illustrated in FIGS. 2 and 3, there are a plurality of nozzles 50 (50-1 to 50-12) disposed on boom arm 22. While illustrated with 12 nozzles 50, there can be any number of nozzles 50 disposed on boom arm 22. Nozzles 50 dispense material (such as fertilizer, herbicide, or pesticide) in a spray. In any of the embodiments, nozzles 50 can be actuated with a pulse width modulation (PWM) actuator to turn the nozzles 50 on and off. In one example, the PWM actuator drives to a specified position (e.g., full open position, full closed position) according to a pulse duration, which is a length of the signal. Any type of fluid dispenser 50 can be used, including any type of nozzle 50, or any other device for applying fluids, such as a tube.

Illustrated in FIG. 2, there are two cameras 70 (70-1 and 70-2) disposed on the boom arm 22 with each camera 70-1 and 70-2 disposed to view half of the boom arm 22. Illustrated in FIG. 3, there are a plurality of cameras 70 (70-1, 70-2, 70-3) each disposed on the boom arm 22 with each viewing a subsection of boom arm 22. While illustrated with three cameras 70, there can be additional cameras 70. In the plurality of camera 70 embodiments, the cameras 70 can each be disposed to view an equal number of nozzles 50 or any number of nozzles 50.

A combined camera 70 includes a light unit. A reference to camera 70 is to either a camera or camera/light unit unless otherwise specifically stated.

Camera 70 can be any type of camera. Examples of cameras include, but are not limited to, digital camera, line scan camera, monochrome, RGB (red, green blue), NIR (near infrared), SWIR (short wave infrared), MWIR (medium wave infrared), LWIR (long wave infrared), optical sensor (including receiver or transmitter/receiver), reflectance sensor, laser.

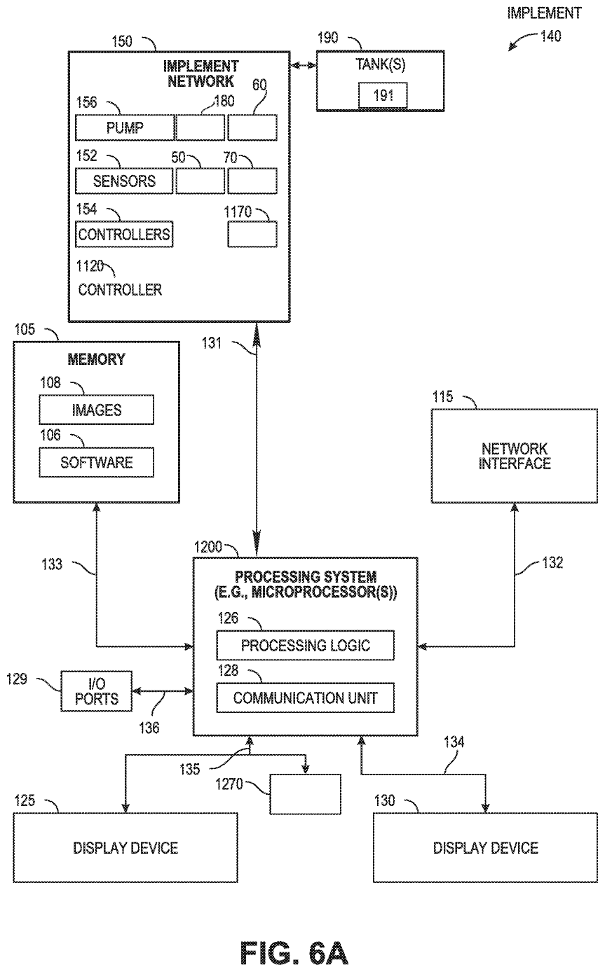

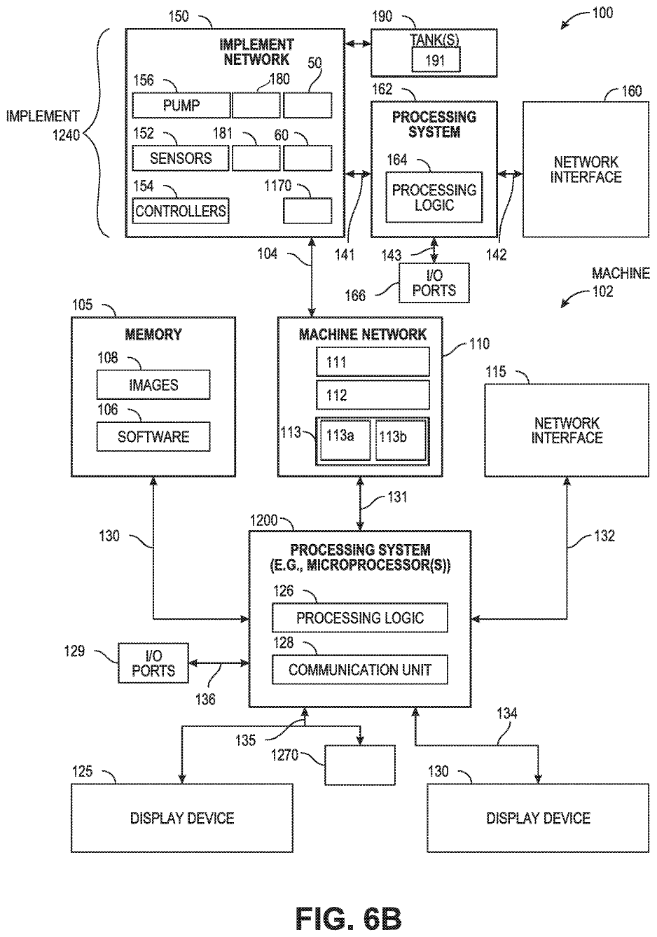

In one embodiment, nozzles 50 and cameras 70 are connected to a network. An example of a network is described in PCT Publication No. WO2020/039295A1 and is illustrated as implement network 150 in FIG. 6A and FIG. 6B.

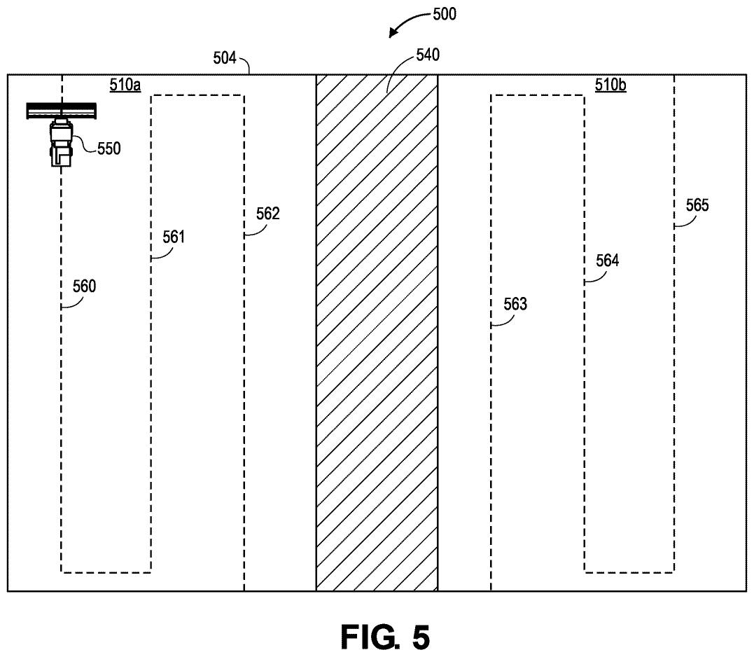

FIG. 4 illustrates a flow diagram of one embodiment for a computer-implemented method of determining a fluid application rate during a fluid application to apply fluids (e.g., fertilizer, herbicide, insecticide, and/or fungicide, etc.) to a fluid application area of a field based on the fluid application area, amount of acreage remaining in the fluid application area to receive the fluid application, and a volume, a quantity, or an amount of fluid in a tank of an implement (e.g., an agricultural vehicle, planter, cultivator, plough, sprayer, spreader, a side-dress bar, a seeder, an irrigator, a center pivot irrigator, a tillage implement, a tractor, a cart, or a robot, etc.). The fluid system (e.g., system 15) includes spray nozzles and one or more cameras that are disposed on an agricultural implement that is traveling through a field for a fluid application pass. The agricultural implement can be moving through the field in parallel with rows of plants. The method 400 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 400 is performed by processing logic (e.g., processing logic 126) of a processing system, of a camera, or of a monitor (e.g., display device 125, 130). The camera can be attached to a boom or any implement as described herein.

At operation 402, the computer-implemented method initiates a software application for a fluid application. At operation 404, the software application receives a field area of a field for a fluid application from a user (e.g., operator, grower, farmer), from a file having previously determining field area of the field, or the field area is calculated by driving the implement around a perimeter of the field and using the GPS coordinates associated with the implement during the pass around the perimeter of field. At operation 405, the computer-implemented method optionally determines an area for non-fluid application regions (e.g., grass area, waterway, drainage area) if any within the field area and subtracts the non-fluid application area from the field area to determine a fluid application area within the field. At operation 406, the computer-implemented method determines a volume, a quantity, and/or weight of fluid in a fluid tank of the implement based on filling of the fluid into the fluid tank or based on a tank sensor to measure a volume, a quantity, and/or amount of fluid in the fluid tank.

At operation 408, the computer-implemented method receives an input for a minimum fluid application rate and a maximum fluid application rate based on fluid label instructions and as permitted by law.

At operation 410, the computer-implemented method determines a first application rate (or initial application rate) for applying the full volume, quantity, or amount of fluid in the tank to the fluid application area of the field based on the fluid application area, the volume of the tank, the minimum application rate, and the maximum application rate in order to empty the volume, quantity, or amount of fluid from the fluid tank when completing the fluid application to the fluid application area. The fluid application can be evenly applied across the fluid application area or different zones with different application rates can be determined based on soil, plant, or weed conditions within different zones. The first application rate is selected to be applied during the fluid application as long as the determined application rate falls within the minimum application rate and the maximum application rate. In one example, the application rate is equal to the minimum application rate, greater than the minimum application rate and less than the maximum application rate, or equal to the maximum application rate.

At operation 412, the computer-implemented method determines whether a predetermined number of application passes has occurred or remains within the field. If so, then at operation 414, the computer-implemented method determines a second application rate (or subsequent application rate) for applying the remaining volume, quantity, or amount of fluid in the tank to a region of the fluid application area that has not yet received a fluid application based on an area of this region and the remaining volume, quantity, or amount of fluid in the tank. The second application rate is selected to be applied during the application pass as long as the second application rate falls within the minimum application rate and the maximum application rate.

If a predetermined number of application passes has not occurred or do not remain within the field, the method continues to monitor the number of application passes that has been performed at operation 412.

The software application can receive a steering angle from a steering sensor of the implement and receive a ground speed of the implement from a speed sensor (e.g., GPS, RADAR wheel sensor). The cameras on the implement can capture a sequence of images while the implement travels through an agricultural field. In one example, the agricultural implement can be moving through the field in parallel with rows of plants and have numerous spray nozzles for a fluid application. The steering angle will indicate whether the implement is traveling in a straight line or with curvature.

Although the operations in the computer-implemented methods disclosed herein are shown in a particular order, the order of the actions can be modified. Thus, the illustrated embodiments can be performed in a different order, and some operations may be performed in parallel. Some of the operations listed in the methods disclosed herein are optional in accordance with certain embodiments. The numbering of the operations presented is for the sake of clarity and is not intended to prescribe an order of operations in which the various operations must occur. Additionally, operations from the various flows may be utilized in a variety of combinations.

FIG. 5 illustrates a route of an implement (e.g., an agricultural vehicle, planter, cultivator, plough, sprayer, spreader, a side-dress bar, a seeder, an irrigator, a center pivot irrigator, a tillage implement, a tractor, a cart, or a robot, etc.) traversing an agricultural field 500 for a fluid application in accordance with one embodiment. The implement 550 includes a fluid system with an applicator to apply fluid to the field. The field 500 includes a boundary 504 or perimeter, fluid application regions 510a, 510b, and a non-fluid application region 540. A route of the implement includes application passes 560-565 that are represented by dashed lines.

In FIG. 5, the implement 550 optionally travels along a boundary 504 (e.g., a perimeter, a border, an edge, etc.) of the field 500, which allows a controller or processing system to determine a shape and dimensions (e.g., a geometry) of the boundary 504 and the field. As discussed above, the software application receives a field area for a fluid application from a user (e.g., operator, grower, farmer) or the field area within the boundary 504 is calculated by driving the implement 550 around a perimeter of the field and using the GPS coordinates associated with the implement 550 during the pass around the perimeter of field. The computer-implemented method 400 can optionally determine an area for non-fluid application region 540 (e.g., grass area, waterway, drainage area) and subtract the non-fluid application area from the field area to determine a fluid application area within the field.

The computer-implemented method 400 determines prior to or during application pass 560 a first application rate (or initial application rate) for applying the full volume, quantity, or amount of fluid in the tank to the fluid application regions 510a, 510b of the field based on the fluid application area and the volume, quantity, or amount of fluid in the tank. The first application rate is selected to be applied during the fluid application as long as the determined application rate falls within the minimum application rate and the maximum application rate.

The computer-implemented method 400 determines whether a predetermined number of application passes (e.g., 1-5 of application passes 560-565) has occurred or remain within the field. If so, then the computer-implemented method determines a second application rate (or subsequent application rate) for applying the remaining volume, quantity, or amount of fluid in the tank to a region of the fluid application area that has not yet received a fluid application based on an area of this region and the remaining volume, quantity, or amount of fluid in the tank. The second application rate is selected to be applied during an application pass as long as the second application rate falls within the minimum application rate and the maximum application rate.

FIG. 6A shows an example of a block diagram of a self-propelled implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 6A. The I/O ports 129 (e.g., diagnostic/on board diagnostic (OBD) port) enable communication with another data processing system or device (e.g., display devices, sensors, etc.).

In one example, the self-propelled implement 140 performs operations for fluid applications of a field. Data associated with the fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as a field view application or fluid application software for analysis of fluid applications and fluid application rates for performing operations of the present disclosure, or any other software application or module, images (e.g., captured images of crops and weeds, images of a spray pattern for rows of crops, images for camera calibrations), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., weed metrics, planting application data, fluid or fluid application data, captured images, localized view map layer, high definition field maps of as-applied fluid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied fluid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, a side-dress bar, a seeder, an irrigator, a center pivot irrigator, a tillage implement, a tractor, a cart, or a robot, etc.) includes an implement network 150 having multiple networks. The implement network 150 having multiple networks (e.g., Ethernet network, Power over Ethernet (POE) network, a controller area network (CAN) serial bus protocol network, an ISOBUS network, etc.) may include a pump 156 for pumping fluid or fluid from a storage tank(s) 190 to row units of the implement, communication module 180 for receiving communications from controllers and sensors and transmitting these communications. Each fluid storage tank 190 can include a tank sensor 191 to determine a level of fluid in the fluid tank to determine a volume, quantity, or amount of fluid in the tank. In one example, the implement network 150 includes nozzles 50 and vision guidance system 1170 having cameras and processors for various embodiments of this present disclosure.

Sensors 152 (e.g., speed sensors, seed sensors for detecting passage of seed, downforce sensors, actuator valves, OEM sensors, flow sensors, etc.), controllers 154 (e.g., drive system, GPS receiver), and the processing system 120 control and monitoring operations of the implement.

The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

FIG. 6B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (POE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 6B. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., weed metrics, planting data, GPS data, fluid application data, flow rates, calibration data for camera calibrations, etc.). The system 1200 includes memory 105 for storing data and programs for execution (software 106) by the processing system. The memory 105 can store, for example, software components such as fluid application software for analysis of fluid applications for performing operations of the present disclosure, or any other software application or module, images (e.g., images for camera calibrations, captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 120 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., weed metrics, planting application data, fluid or fluid application data, captured images, localized view map layer, high definition field maps of as-applied fluid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied fluid or fluid application data, as-planted or as-harvested data, yield data, controlling a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e. g, Ethernet network, Power over Ethernet (POE) network, a controller area network (CAN) serial bus protocol network, an ISOBUS network, etc.) may include a pump 156 for pumping fluid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes nozzles 50 and vision guidance system 1170 having cameras and processors, and autosteer controller 1120 for various embodiments of this present disclosure. The autosteer controller 1120 may also be part of the machine network 110 instead of being located on the implement network 150 or in addition to being located on the implement network 150.

Sensors 152 (e.g., speed sensors, seed sensors for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, fluid application sensors for a sprayer, or vacuum, lift, lower sensors for an implement. For example, the controllers may include processors in communication with a plurality of seed sensors. The processors are configured to process data (e.g., fluid application data, seed sensor data) and transmit processed data to the processing system 162 or 120. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 6B.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

In one embodiment, a machine-accessible non-transitory medium (e.g., memory 105) contains executable computer program instructions which when executed by a data processing system cause the system to perform operations or methods of the present disclosure.

It will be appreciated that additional components, not shown, may also be part of the system in certain embodiments, and in certain embodiments fewer components than shown in FIG. 6A and FIG. 6B may also be used in a data processing system. It will be appreciated that one or more buses, not shown, may be used to interconnect the various components as is well known in the art.

Examples—The following are non-limiting examples.

Example 1—an implement comprising a fluid tank to store a volume, quantity, or amount of fluid, a plurality of nozzles disposed along the implement to apply a fluid application as the implement travels through an agricultural field, and a processing system including a processor that is configured to receive a field area of a field for a fluid application or to calculate the field area based on driving the implement around a perimeter of the agricultural field, to determine a volume, quantity, or amount of fluid in the fluid tank based on filling of the fluid into the fluid tank of the implement or based on a tank sensor to measure a volume, quantity, or amount of fluid in the fluid tank, to receive an input for a minimum fluid application rate and a maximum fluid application rate based on fluid label instructions, and to determine a first application rate for applying the volume, quantity, or amount of fluid currently in the fluid tank to a fluid application area of the field based on the fluid application area and the volume, quantity, or amount of fluid currently in the fluid tank in order to empty the volume, quantity, or amount of fluid from the fluid tank when completing the fluid application to the fluid application area.

Example 2—the implement of Example 1, wherein the first application rate is selected to be applied during the fluid application when the first application rate falls within the minimum application rate and the maximum application rate.

Example 3—the implement of any preceding Example, wherein the processor is further configured to determine whether a predetermined number of application passes for a route of the implement through the fluid application area has occurred.

Example 4—the implement of any preceding Example, wherein the processor is further configured, given a predetermined number of application passes for a route of the implement through the fluid application area has occurred, to determine a second application rate for applying a remaining volume, quantity, or amount of fluid in the fluid tank to a region of the fluid application area that has not received the fluid application based on an area of this region and the remaining volume, quantity, or amount of fluid in the fluid tank.

Example 5—the implement of any preceding Example, wherein the fluid application area is less than the field area of the field.

Example 6—a system comprising memory to store fluid application data for a fluid tank of an implement and field data for one or more fields and a processor communicatively coupled to the memory. The processor is configured to receive a field area of a field for a fluid application or to calculate the field area by driving the implement around a perimeter of the field, to determine a volume, a quantity, or an amount of fluid in the fluid tank of the implement based on filling of the fluid into the fluid tank of the implement or based on a tank sensor to measure a volume, quantity, or amount of fluid in the fluid tank, to receive an input for a minimum fluid application rate and a maximum fluid application rate based on fluid label instructions, and to determine an application rate for applying the volume, quantity, or amount of fluid currently in the fluid tank to a fluid application area of the field based on the minimum fluid application rate, the maximum fluid application rate, a fluid application area, and the volume, quantity, or amount of fluid currently in the fluid tank in order to empty the volume, quantity, or amount of fluid from the fluid tank when completing the fluid application to the fluid application area.

Example 7—system of Example 6, wherein the fluid application area is less than the field area of the field.

Example 8—system of any of Examples 6-7, wherein the processor is further configured to determine a non-fluid application area for non-fluid application regions.

Example 9—system of any of Examples 6-8, wherein the processor is further configured to subtract the non-fluid application area from the field area to determine the fluid application area within the field.

Example 10—system of any of Examples 6-9, wherein the implement comprises a tractor or a sprayer.

Example 11 is a computer-implemented method, comprising receiving a field area of a field for a fluid application or calculating the field area by driving an implement around a perimeter of the field, determining a volume, quantity, or amount of fluid in a fluid tank based on filling of the fluid into the fluid tank of the implement or based on a tank sensor to measure a volume, quantity, or amount of fluid in the fluid tank, receiving an input for a minimum fluid application rate and a maximum fluid application rate based on fluid label instructions, and determining a first application rate for applying the volume, quantity, or amount of fluid currently in the fluid tank to a fluid application area of the field based on the fluid application area and the volume, quantity, or amount of fluid currently in the fluid tank in order to empty the volume, quantity, or amount of fluid from the fluid tank when completing the fluid application to the fluid application area.

Example 12—the computer-implemented method of Example 11, wherein the first application rate is selected to be applied during the fluid application when the first application rate falls within the minimum application rate and the maximum application rate.

Example 13—the computer-implemented method of any of Examples 11-12, further comprising determining whether a predetermined number of application passes for a route of the implement through the fluid application area has occurred.

Example 14—the computer-implemented method of any of Examples 11-13, further comprising given a predetermined number of application passes occurring for a route of the implement through the fluid application area, determining a second application rate for applying a remaining volume, quantity, or amount of fluid in the fluid tank to a region of the fluid application area that has not received a fluid application based on an area of this region and the remaining volume, quantity, or amount of fluid in the fluid tank.

Example 15—the computer-implemented method of any of Examples 11-14, further comprising determining whether a predetermined number of application passes remains for a route of the implement through the fluid application area.

Example 16—the computer-implemented method of any of Examples 11-15, further comprising given a predetermined number of application passes remaining for a route of the implement through the fluid application area, determining a third application rate for applying a remaining volume, quantity, or amount of fluid in the fluid tank to a region of the fluid application area that has not received the fluid application based on an area of this region and the remaining volume, quantity, or amount of fluid in the fluid tank.

Example 17—the computer-implemented method of any of Examples 11-16, wherein the fluid application area is less than the field area of the field.

Example 18—the computer-implemented method of any of Examples 11-17, further comprising determining a non-fluid application area for non-fluid application regions.

Example 19—the computer-implemented method of any of Examples 11-18, further comprising subtracting the non-fluid application area from the field area to determine the fluid application area within the field.

Example 20—the computer-implemented method of any of Examples 11-19, wherein the implement comprises a tractor or a sprayer.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. An implement comprising:
a fluid tank to store a volume, quantity, or amount of fluid;
a plurality of fluid dispensers disposed along the implement to apply a fluid application as the implement travels through an agricultural field; and
a processing system including a processor that is configured to receive a field area of a field for a fluid application or to calculate the field area based on driving the implement around a perimeter of the agricultural field, to determine a volume, quantity, or amount of fluid in the fluid tank based on filling of the fluid into the fluid tank of the implement or based on a tank sensor to measure a volume, quantity, or amount of fluid in the fluid tank, to receive an input for a minimum fluid application rate and a maximum fluid application rate based on fluid label instructions, and to determine a first application rate for applying the volume, quantity, or amount of fluid currently in the fluid tank to a fluid application area of the field based on the fluid application area and the volume, quantity, or amount of fluid currently in the fluid tank in order to empty the volume, quantity, or amount of fluid from the fluid tank when completing the fluid application to the fluid application area.

2. The implement of claim 1, wherein the first application rate is selected to be applied during the fluid application when the first application rate falls within the minimum application rate and the maximum application rate.

3. The implement of claim 1, wherein the processor is further configured to determine whether a predetermined number of application passes for a route of the implement through the fluid application area has occurred.

4. The implement of claim 3, wherein the processor is further configured, given a predetermined number of application passes for a route of the implement through the fluid application area has occurred, to determine a second application rate for applying a remaining volume, quantity, or amount of fluid in the fluid tank to a region of the fluid application area that has not received the fluid application based on an area of this region and the remaining volume, quantity, or amount of fluid in the fluid tank.

5. The implement of claim 1, wherein the fluid application area is less than the field area of the field.

6. A system comprising:
memory to store fluid application data for a fluid tank of an implement and field data for one or more fields; and
a processor communicatively coupled to the memory, the processor is configured to receiving a field area of a field for a fluid application or to calculate the field area by driving the implement around a perimeter of the field, to determine a volume, a quantity, or an amount of fluid in the fluid tank of the implement based on filling of the fluid into the fluid tank of the implement or based on a tank sensor to measure a volume, quantity, or amount of fluid in the fluid tank, to receive an input for a minimum fluid application rate and a maximum fluid application rate based on fluid label instructions, and to determine an application rate for applying the volume, quantity, or amount of fluid currently in the fluid tank to a fluid application area of the field based on the minimum fluid application rate, the maximum fluid application rate, a fluid application area, and the volume, quantity, or amount of fluid currently in the fluid tank in order to empty the volume, quantity, or amount of fluid from the fluid tank when completing the fluid application to the fluid application area.

7. The system of claim 6, wherein the fluid application area is less than the field area of the field.

8. The system of claim 6, wherein the processor is further configured to determine a non-fluid application area for non-fluid application regions.

9. The system of claim 8, wherein the processor is further configured to subtract the non-fluid application area from the field area to determine the fluid application area within the field.

10. The system of claim 6, wherein the implement comprises a tractor or a sprayer.

11. A computer-implemented method, comprising:
receiving a field area of a field for a fluid application or calculating the field area by driving an implement around a perimeter of the field;
determining a volume, quantity, or amount of fluid in a fluid tank based on filling of the fluid into the fluid tank of the implement or based on a tank sensor to measure a volume, quantity, or amount of fluid in the fluid tank;
receiving an input for a minimum fluid application rate and a maximum fluid application rate based on fluid label instructions; and
determining a first application rate for applying the volume, quantity, or amount of fluid currently in the fluid tank to a fluid application area of the field based on the fluid application area and the volume, quantity, or amount of fluid currently in the fluid tank in order to empty the volume, quantity, or amount of fluid from the fluid tank when completing the fluid application to the fluid application area.

12. The computer-implemented method of claim 11, wherein the first application rate is selected to be applied during the fluid application when the first application rate falls within the minimum application rate and the maximum application rate.

13. The computer-implemented method of claim 11, further comprising:
determining whether a predetermined number of application passes for a route of the implement through the fluid application area has occurred.

14. The computer-implemented method of claim 13, further comprising:
given a predetermined number of application passes occurring for a route of the implement through the fluid application area, determining a second application rate for applying a remaining volume, quantity, or amount of fluid in the fluid tank to a region of the fluid application area that has not received a fluid application based on an area of this region and the remaining volume, quantity, or amount of fluid in the fluid tank.

15. The computer-implemented method of claim 11, further comprising:
determining whether a predetermined number of application passes remains for a route of the implement through the fluid application area.

16. The computer-implemented method of claim 15, further comprising:
given a predetermined number of application passes remaining for a route of the implement through the fluid application area, determining a third application rate for applying a remaining volume, quantity, or amount of fluid in the fluid tank to a region of the fluid application area that has not received the fluid application based on an area of this region and the remaining volume, quantity, or amount of fluid in the fluid tank.

17. The computer-implemented method of claim 11, wherein the fluid application area is less than the field area of the field.

18. The computer-implemented method of claim 11, further comprising:
determining a non-fluid application area for non-fluid application regions.

19. The computer-implemented method of claim 18, further comprising:
subtracting the non-fluid application area from the field area to determine the fluid application area within the field.

20. The computer-implemented method of claim 11, wherein the implement comprises a tractor or a sprayer.
